(19) United States
(12) Patent Application Publication
(10) Pub. No.: US 2012/0236946 A1
(43) Pub. Date: Sep. 20, 2012

(54) MULTIMEDIA STREAM DISPLAYING SYSTEM AND METHOD THEREOF

(75) Inventors: Yu-Chun CHEN, Hsinchu City (TW); Po-Hsin LUO, Hsinchu City (TW); Yu-Chin TAI, Hsinchu City (TW); Kai-Ting LIN, Hsinchu City (TW); Yen-Yi CHIANG, Hsinchu City (TW); Chung-Yi KE, Hsinchu City (TW); Tsai-Feng CHUNG, Hsinchu City (TW); Fu-Chun YANG, Hsinchu City (TW); Sheng-Yu SUN, Hsinchu City (TW)

(73) Assignee: SKYVIIA CORPORATION, HSINCHU CITY (TW)

(21) Appl. No.: 13/403,184

(22) Filed: Feb. 23, 2012

(30) Foreign Application Priority Data
Mar. 17, 2011 (TW) 100109068

(51) Int. Cl. H04N 7/26

(52) U.S. Cl. 375/240.25; 375/E07.027

(57) ABSTRACT

A multimedia stream displaying method is disclosed. The method includes the following steps: firstly, a portable decoder unit is embedded between an application layer and a hardware layer. Then, a specific stream format of the hardware layer is inquired. A plurality of multimedia streams from the application layer are received and decoded, and the decoded multimedia streams are encapsulated in the specific stream format. Finally, the encapsulated multimedia streams are transmitted to the hardware layer to be displayed.

### CROSS-REFERENCE TO RELATED APPLICATIONS

The entire contents of Taiwan Patent Application No. 100109068, filed on Mar. 17, 2011, from which this application. claims priority, are incorporated herein by reference.

### BACKGROUND OF THE INVENTION

1. Field of the Invention

The present invention generally relates to a multimedia processing system, and more particularly to a multimedia stream displaying system and method thereof.

2. Description of Related Art

Audio-visual entertainment has become one of the major entertainments of people. As a user initiates a multimedia stream processing application such as Mplayer at the application-end, the multimedia stream is transmitted to a hardware layer to be processed and then to be displayed. However, various hardware layer manufactured by different manufacturers may be in different formats, and which result in that the software executed by various hardware layers are not compatible.

Therefore, a need has arisen to propose a novel multimedia stream displaying system which can display multimedia stream independent of the compatibility between the application and hardware layers.

### SUMMARY OF THE INVENTION

In view of the foregoing, it is an object of the present invention. to provide a multimedia stream displaying system and method thereof which embeds a portable decoder program between an application layer and a hardware layer, so as to flexibly execute the portable decoder program at any system to display video information.

According to one embodiment, a multimedia stream displaying system is disclosed. The multimedia stream displaying system includes an application layer, a hardware layer, and a portable decoder unit. The application layer is configured to provide a plurality of multimedia streams, and the hardware layer has a specific stream format. The portable decoder unit, embedded between the application layer and the hardware layer, is configured to receive and decode the multimedia streams, and encapsulate the decoded multimedia streams in the specific stream format and transmit them to the hardware layer. Wherein, the hardware layer sequentially displays the packages from the portable decoder unit in a display device.

According to another embodiment, a multimedia stream displaying method is disclosed. The method includes the following steps: firstly, a portable decoder unit is embedded between an application layer and a hardware layer. Then, a specific stream format of the hardware layer is inquired. A plurality of multimedia streams from the application layer are received and decoded, and the decoded multimedia streams are encapsulated in the specific stream format. Finally, the encapsulated multimedia streams are transmitted to the hardware layer to be displayed.

### BRIEF DESCRIPTION OF THE DRAWINGS

FIG. 1 illustrates a multimedia stream displaying system according to one embodiment of the present invention; and

FIG. 2 illustrates a process of multimedia stream displaying method according to one embodiment of the present invention.

### DETAILED DESCRIPTION OF THE INVENTION

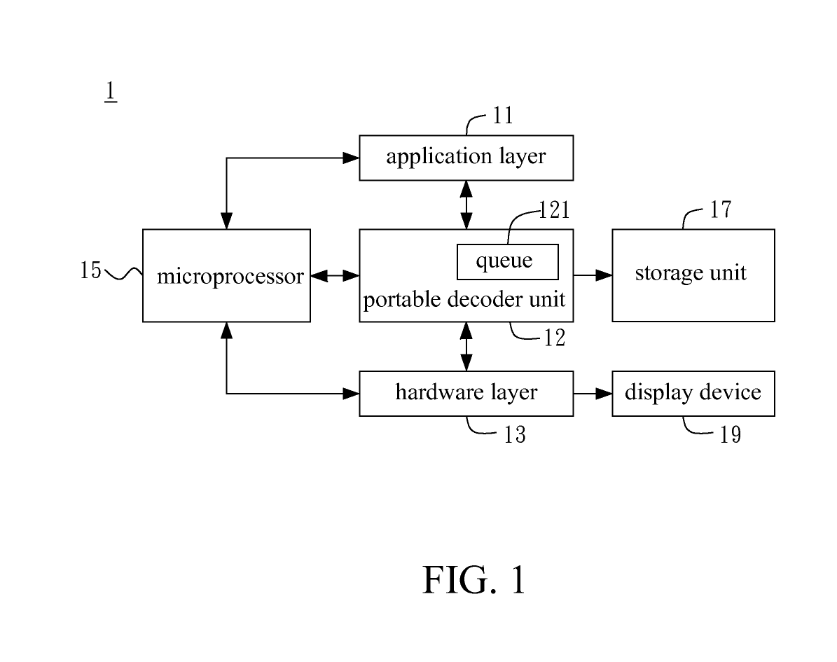

Firstly, FIG. 1 illustrates a multimedia stream displaying system according to one embodiment of the present invention. As shown in FIG. 1, the multimedia stream displaying system 1 includes an application layer 11, a portable decoder unit 12, a hardware layer 13, a microprocessor 15, a storage unit 17, and a display device 19. The application layer 11, over user end, is configured to provide a plurality of multimedia streams to the portable decoder unit 12 to perform decoding. Specifically, the multimedia streams may be, but not limited to, one of the audio or video files stored in the storage unit 17 previously, or digital signals transmitted via a network or an antenna. Each of the multimedia streams is the smallest unit that the portable decoder unit 12 can process, and the multimedia streams may be coded, but not limited to, in the form of MPEG, AVI, MP3, or WAVE.

The portable decoder unit 12, embedded between the application layer 11 and. the hardware layer 13, is configured to receive and decode the multimedia streams. The hardware layer 13 has a specific stream format. The portable decoder unit 12 must encapsulate the decoded multimedia streams in the specific stream format and transmit them to the hardware layer 13, so that the hardware layer 13 could obtain the payload, of the encapsulated multimedia streams based. on its specific stream format, and further sequentially display the payload in the display device 19. Specifically, the hardware layer 13 may be, but not limited, to, a display card or a sound card.

The microprocessor 15 is configured to control the whole operation of the multimedia stream displaying system 1. The storage unit 17 configured. to store the decoded multimedia streams to be repeatedly displayed later. In one embodiment, the microprocessor 15 comprises an ARM9 processor; and the storage unit 17 comprises an external hard disk, a flash memory, a dynamic random access memory (DRAM), or a static random access memory (SRAM).

The portable decoder unit 12 of the present invention is suitable for various coding formats of the multimedia streams, and suitable for various specific stream formats that the hardware layer 13 has Specifically, the portable decoder unit 12 is a segment of program code, and which is stored into an optical disk. When the portable decoder unit 12 is embedded into any multimedia stream displaying system 1, the portable decoder unit 12 may be compiled and then inquire the formats of the application layer 11 and the hardware layer 13, so that the portable decoder unit 12 can decode the multimedia streams based on the format of the multimedia streams later, and convert them into the information that the hardware layer 13 could recognize.

Besides converting, the use of the portable decoder unit 12 also can adjust the decoding rate. In one embodiment, the portable decoder unit 12 includes a temporary queue 121 which is configured. to temporarily store the multimedia streams from the application layer 11. When decoding the multimedia streams, the portable decoder unit 12 may adjust the use of the temporary queue 121 according to decoding rate. For example, when the decoding rate is so slow that too much multimedia streams are accumulated in the temporary queue 121, the portable decoder unit 12 may signal the application layer 11 to stop transmitting new multimedia streams, so as to prevent losing audio information due to the overflow of the temporary queue 121.

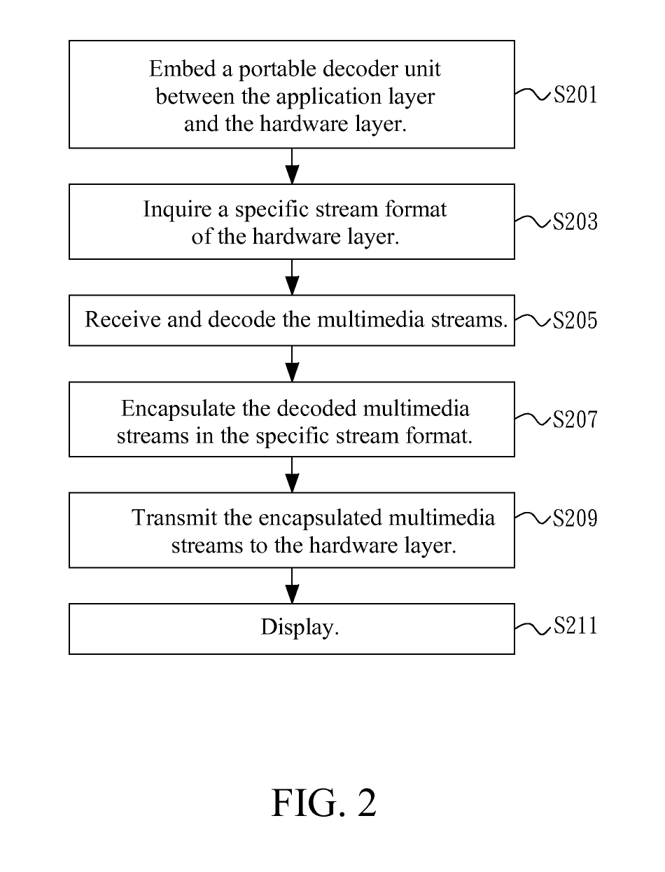

In order to further understand the operation of the present invention, please refer to FIG. 2. FIG. 2 illustrates a process of multimedia stream displaying method according to one embodiment of the present invention. The multimedia stream displaying method described herein includes the following steps:

Initially, the microprocessor 15 compiles the portable decoder unit 12, so as to embed it between the application layer 11 and the hardware layer 13 (step S201). Then, the portable decoder unit 12 inquires the coding format of the application layer 11 and the specific stream format of the hardware layer 13 (step S203).

After recognizing the format information of both upper and lower layers, the portable decoder unit 12 receives and decodes the multimedia streams from the application layer 11 (step S205). Afterwards, the portable decoder unit 12 encapsulates the decoded multimedia streams in the specific stream format (step S207), and transmits them to the hardware layer 13 (step S209). It is noted. that the portable decoder unit 12 may adjust the rate of receiving the multimedia streams according to decoding rate during decoding. And the decoded multimedia streams may be stored in the storage unit 17 during decoding.

Finally, after receiving the packages from the upper layer by the hardware layer 13, the hardware layer 13 obtains the payload of the encapsulated multimedia streams based on its specific stream format, and further sequentially displays the payload in a display device 19 (step S211).

Although specific embodiments have been illustrated and described, it will be appreciated by those skilled in the art that various modifications may be made without departing from the scope of the present invention, which is intended to be limited solely by the appended claims.

What is claimed is:

1. A multimedia stream displaying system, comprising:
an application layer configured to provide a plurality of multimedia streams;
a hardware layer having a specific stream format; and
a portable decoder unit, embedded between the application layer and the hardware layer, configured to receive and decode the multimedia streams, and encapsulate the decoded multimedia streams in the specific stream format and then transmit them to the hardware layer;
whereby, the hardware layer displays the packages from the portable decoder unit in a display device.

2. The multimedia stream displaying system of claim 1, further comprising:
a microprocessor configured to control the whole operation of the multimedia stream displaying system; and
a storage unit configured to store the decoded multimedia streams.

3. The multimedia stream displaying system of claim 2, wherein the portable decoder unit comprises;
temporary queue configured to temporarily store the multimedia streams;
wherein, the portable decoder unit adjusts the use of the temporary queue according to decoding rate.

4. The multimedia stream displaying system of claim 1, wherein the portable decoder unit is suitable for various coding formats of the multimedia streams, and suitable for various specific stream formats that the hardware layer has.

5. The multimedia stream displaying system of claim 4, wherein the multimedia streams are coded in the form of MPEG, AVI, MP3, or WAVE.

6. The multimedia stream displaying system of claim 1, wherein the hardware layer comprises a display card or a sound card.

7. The multimedia stream displaying system of claim 2, wherein the microprocessor comprises an ARM9 processor.

8. The multimedia stream displaying system of claim 2, wherein the storage unit comprises an external hard disk, a flash memory, a dynamic random access memory (DRAM), or a static random access memory (SRAM).

9. A multimedia stream displaying method, comprising:
embedding a portable decoder unit between an application layer and a hardware layer;
inquiring a specific stream format of the hardware layer;
receiving and decoding a plurality of multimedia streams from the application layer;
encapsulating the decoded multimedia streams in the specific stream format; and
transmitting the encapsulated multimedia streams to the hardware layer to be displayed.

10. The multimedia stream displaying method of claim 9, further comprising:
adjusting the rate of receiving the multimedia streams according to decoding rate.

11. The multimedia stream displaying method of claim 10, further comprising:
storing the decoded multimedia streams.

12. The multimedia stream displaying method of claim 9, wherein the portable decoder unit is suitable for various coding formats of the multimedia streams, and suitable for various specific stream formats that the hardware layer has.

13. The multimedia stream displaying method of claim 9, wherein the multimedia streams are coded in the form of MPEG, AVI, MP3, or WAVE.

14. The multimedia stream displaying method of claim 9, wherein the hardware layer comprises a display card or a sound card.

15. The multimedia stream displaying method of claim 11, wherein the multimedia streams are stored in an external hard disk, a flash memory, a dynamic random access memory (DRAM), or a static random access memory (SRAM).
